(19) United States
(12) Patent Application Publication
(10) Pub. No.: US 2007/0175519 A1
(43) Pub. Date: Aug. 2, 2007

(54) Injector valve in injector for gas fuel

(76) Inventor: Motoharu Moriya, Atsugi-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 11/580,115

(22) Filed: Oct. 13, 2006

(30) Foreign Application Priority Data
Feb. 1, 2006 (JP) 2006-024063

(51) Int. Cl. F16L 7/00

(52) U.S. Cl. 137/375

(57) ABSTRACT

The sticking phenomenon between a coating film and a metal seat caused by a fluorine resin of a valve member can be avoided when a dissolution of a plasticizer from a fuel hose is much, and an excellent durability can be achieved when the operation is continued thereafter and the dissolution of the plasticizer is reduced. In an injector valve in an injector for a gas fuel, the injector valve has an injector valve member having a close-contact member arranged on an acting surface thereof, the close-contact member including a base material formed by a rubber material and a fluorine resin coating film formed on the surface of the base material. The fluorine resin coating film is formed by a first fluorine resin coating film applied to the surface of the base material and having an excellent durability, and a second fluorine resin coating film applied to the first fluorine resin coating film and having an excellent release characteristic.

### BACKGROUND OF THE INVENTION

1. Field of the Invention

The present invention relates to an injector valve constituting an injector used for injecting a gas fuel such as a liquefied natural gas (LPG) or the like into an intake passage of an internal combustion engine.

2. Description of Related Art

Conventionally, in an injector continuously injecting a predetermined amount of fuel gas into an intake passage in an internal combustion engine employing a gas fuel such as the LPG or the like at a predetermined interval, an injector valve member 1 opening and closing an injection passage has a base material 2 formed by a rubber material on the acting surface thereof, as shown in FIG. 3, on the basis of the necessity for cutting off the high-pressure fuel gas, and a coating film 4 made of a fluorine resin is formed on the surface particularly for the purpose of improving a close-contacting characteristic and a release characteristic to and from a metal seat 3 arranged so as to face to the base material 2.

However, a plasticizer is included in a rubber hose used in a fuel pipe line supplying the fuel to the injector, the plasticizer is dissolved in the fuel so as to act on the fluorine resin coating film 4, and there is generated a state in which a sticking is produced between the injector valve member 1 and the metal seat 3, so that there is generated a problem such as a defect of an engine start, a deterioration of an operation performance or the like. In particular, a lot of plasticizer is included in a new hose, the new hose is affected significantly.

In this case, there has been known that the sticking characteristic generated between the injector valve member 1 and the metal seat 3 is dependent upon the fluorine resin coated on the injector valve member 1, particularly a binder resin used for closely attaching the fluorine resin. For example, in general, the fluorine resin coating film 4 formed in the case of using an epoxy binder resin has an excellent durability, but tends to generate the sticking with respect to the metal seat due to the plasticizer, and the fluorine resin coating film 4 formed in the case of using a phenol binder resin is hard to generate the sticking, but has an inferior durability.

Accordingly, since there are required both of the sticking prevention and the durability application at a time of coating the fluorine resin to the injector valve member 1, it is extremely hard to select the binder resin.

Further, for example, there can be considered a use of plural kinds of binder resins blended in such a manner as to prevent the sticking and apply the durability. However, since a dissolving amount of the plasticizer is changed in the rubber hose dissolving the plasticizer in the fuel between the new one and the old one, a used condition becomes different even if a blending ratio is changed. Accordingly, it is hard to correspond thereto at a high level.

Therefore, in conventional, the fluorine resin coating film 4 using one kind of binder resin is used as shown in FIG. 3, thereby selecting any one of the improvement of the starting performance or the operation performance by preventing the sticking and the durability and making a sacrifice of any one of them, under the actual condition.

### SUMMARY OF THE INVENTION

The present invention is made by taking the above circumstances mentioned above into consideration, and an object of the present invention is to provide an injector valve in an injector for a gas fuel which can avoid a sticking phenomenon between a coating film and a metal seat caused by a fluorine resin of a valve member when a plasticizer from a new fuel hose is much, and can achieve an excellent durability when the operation is continued thereafter and a dissolution of the plasticizer from the fuel hose is reduced.

In order to achieve the object mentioned above, in accordance with the present invention, there is provided an injector valve in an injector for a gas fuel, the injector valve having an injector valve member having a close-contact member arranged on an acting surface thereof, the close-contact member comprising a base material formed by a rubber material and a fluorine resin coating film formed on a surface of the base material, wherein the fluorine resin coating film is formed by a first fluorine resin coating film applied to the surface of the base material and having an excellent durability, and a second fluorine resin coating film applied to the first fluorine resin coating film and having an excellent release characteristic.

When the injector valve is new, that is, when the plasticizer from the rubber hose is much dissolved and the injector valve member is stuck to the metal seat at a high frequency, it is possible to effectively prevent the sticking on the basis of the second fluorine resin coating film exposed to the surface of the injector valve member and being excellent in the release characteristic. Next, since the second fluorine resin coating film is inferior in the durability, the adhesion portion to the metal seat wears out during the continuous operation, however, the dissolution of the plasticizer from the rubber hose is reduced at that time, and the sticking phenomenon is reduced. Further, the first fluorine resin coating film arranged in the inner side of the second fluorine resin coating film achieving the durability and being excellent in the durability is exposed due to the consumption of the second fluorine resin coating film so as to be in contact with the metal seat, thereby securing a long term use.

Further, in the case that the first fluorine resin coating film is formed by the fluorine resin using the epoxy binder resin, and the second fluorine resin coating film is formed by the fluorine resin coating film using the phenol binder resin, it is possible to extremely easily carry out the present invention.

As mentioned above, in accordance with the present invention, it is possible to achieve both of the sticking on the basis of the dissolution of the plasticizer caused by the fuel between the injector valve member and the metal seat, and the durability, and the means can be achieved only by forming the fluorine resin coating film using one kind of binder resin in two layers. Accordingly, it is not necessary to employ a complicated blend and a special technique, and an excellent effect can be obtained in an economy.

### BRIEF DESCRIPTION OF THE DRAWINGS

FIG. 1 is an enlarged partial schematic view showing a preferable embodiment in accordance with the present invention;

FIG. 2 is an enlarged partial schematic view showing a state after passing through an initial used time of the embodiment shown in FIG. 1; and

FIG. 3 is an enlarged partial schematic view showing a prior art.

### DESCRIPTION OF PREFERRED EMBODIMENTS

Next, a description will be given in detail of a preferable embodiment in accordance with the present invention with reference to the accompanying drawings.

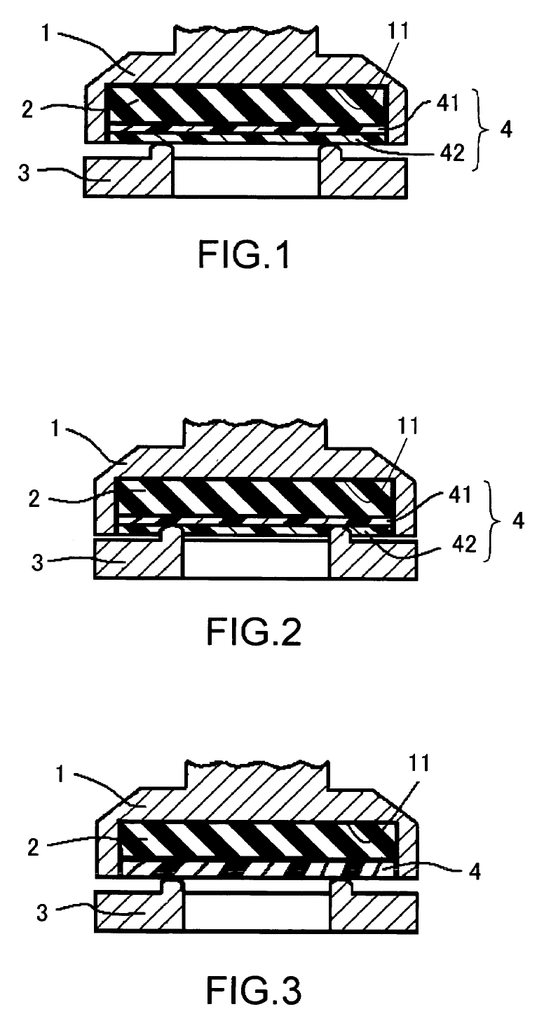

FIG. 1 is a schematic view showing a relation between an injector valve member 1 in an injector for a gas fuel and a metal seat 3 brought in close-contact with the injector valve member 1 in accordance with the present invention. A base material 2 formed by a rubber material is fitted in a concave portion 111 formed in a leading end of the injector valve member 1, and a fluorine resin coating film 4 is formed on the surface of the base material 2.

Further, the fluorine resin coating film 4 is formed, for example, by a first fluorine resin coating film 41 formed by a fluorine resin using an epoxy binder resin and being excellent in a durability, and a fluorine resin coating film 42 applied on the first fluorine resin coating film 41 and using a phenol binder resin.

In this case, the two-layered fluorine resin coating films 41 and 42 are obtained by forming the first fluorine resin coating film 41 becoming the lower layer, and thereafter forming the second fluorine resin coating film 42 thereon, and a forming means for each of the fluorine resin coating films 41 and 42 can employ a conventionally generally known fluorine resin coating film forming means.

In accordance with the present embodiment mentioned above, when the structure is first used, that is, the structure is new at which the dissolving amount of the plasticizer from the rubber tube is much and the sticking is generated at a high frequency, the fluorine resin coating film 42 using the phenol binder resin for the purpose of preventing the sticking is exposed to the surface of the acting surface of the injector valve member 1. Accordingly, it is possible to effectively prevent the sticking generated with respect to the metal seat 3.

Next, since the second fluorine resin coating film 42 is inferior in the durability, the adhesion portion to the metal seat 3 wears out during the repeated operation, as shown in FIG. 2, and the first fluorine resin coating film 41 arranged in the inner side of the second fluorine resin coating film is exposed so as to be in contact with the metal seat 3.

The dissolution of the plasticizer from the rubber hose is reduced at that time, the sticking phenomenon is reduced, and the first fluorine resin coating film 41 achieving the durability is exposed, thereby avoiding deterioration due to a collision with the metal seat 3 and securing a long term use.

As mentioned above, in accordance with the present embodiment, it is possible to achieve both of the initial performance and the durability of the injector by doubling the fluorine resin coating films having the different natures.

In this case, the present invention is not limited to the injector of the type shown in the present embodiment, but can be applied in the same manner to an injector valve member in the other type of injector.

What is claimed is:

1. An injector valve in an injector for a gas fuel, the injector valve having an injector valve member having a close-contact member arranged on an acting surface thereof, the close-contact member comprising a base material formed by a rubber material and a fluorine resin coating film formed on a surface of the base material, wherein the fluorine resin coating film is formed by a first fluorine resin coating film applied to the surface of the base material and having an excellent durability, and a second fluorine resin coating film applied to the first fluorine resin coating film and having an excellent release characteristic.

2. The injector valve in an injector for a gas fuel as claimed in claim 1, wherein the first fluorine resin coating film is formed by a fluorine resin using an epoxy binder resin, and the second fluorine resin coating film is formed by a fluorine resin coating film using a phenol binder resin.
